(19) United States
(12) Patent Application Publication
(10) Pub. No.: US 2026/0259692 A1
(43) Pub. Date: Sep. 3, 2026

(54) COMPUTER-IMPLEMENTED TEXT PRESENTATION AND INTERACTION SYSTEM FOR ADAPTIVE READING AND INPUT ASSISTANCE

(71) Applicants: Stephen O. Behunin, Springville, UT (US); Yitzi Kempinski, Jerusalem (IL)

(72) Inventors: Stephen O. Behunin, Springville, UT (US); Yitzi Kempinski, Jerusalem (IL)

(21) Appl. No.: 19/536,118

(22) Filed: Feb. 10, 2026

Related U.S. Application Data
(60) Provisional application No. 63/756,737, filed on Feb. 10, 2025.

(51) Int. Cl. G06F 3/16; G06F 3/01; G06F 3/04817; G06F 3/0488

(52) U.S. Cl. CPC G06F 3/16; G06F 3/013; G06F 3/04817; G06F 3/0488

(57) ABSTRACT

Systems and methods are disclosed for multimodal user interaction with text using eye-tracking and spatialized audio output. A computing device displays text on a display while an image sensor captures image data representing eye movement of a user. The method and system determines gaze position and reading progression based on the captured image data. A stereo audio output device generates a spatialized audio signal including a first audio output and a second audio output that transition between spatial positions over time according to the detected reading progression. The method and system dynamically adjusts the spatialized audio signal transition based on measured reading rate and gaze movement to synchronize audio output with user interaction with displayed text.

### CROSS-REFERENCE TO RELATED APPLICATIONS

This application claims the benefit of U.S. Provisional Patent Application No. 63/756,737, filed February 10, 2025, which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

The disclosure relates generally to software applications in the field of education, reading, and healthcare. In particular, this disclosure relates to software applications for assisting in and providing training for reading rate, comprehension, attention control, and working around Fine Motor-Muscle Dyspraxia.

### BACKGROUND

Dyspraxia, also known as developmental coordination disorder (DCD), is a neurodevelopmental disorder characterized by difficulties with motor coordination and planning. Common symptoms include clumsiness and poor balance. Fine Motor-Muscle Dyspraxia, which directly inhibits reading rate, skills, attention control, self-confidence, self-worth, eye and hand movement, and depth perception/athletic performance (as opposed to Gross Motor-Muscle Dyspraxia, which most affects the functionality of the arms and legs), is seldom detected, diagnosed, or treated, because there has been no effective and efficient means of working-around Fine Motor-Muscle Dyspraxia, which is currently and generally believed to be an incurable disability.

Dyspraxia, generally, is a chronic neuro-developmental condition that inhibits the coordination of neural brain messaging to both the Gross neural motor-muscle receptors of the arm and leg, and the Fine neural motor-muscle receptors of the eyes, fingers, tongue, and esophagus muscles, etc.

Dyspraxia is most often “detected and diagnosed” as Gross Dyspraxia in young children as they struggle abnormally to crawl, stand, and walk. The disorder is diagnosed in only a relatively small percentage of the total population; for example, approximately 10% of the population.

Dyspraxia is not a YES/NO disability/condition, like mumps or measles. It is instead a spectrum-type of condition that also significantly, but less-obviously, inhibits the fine motor muscles of the eyes and hands, thereby inhibiting reading, reading rate, attention control, depth perception, and athletic performance.

Hence, Dyspraxia inhibits/reduces reading rates, comprehension, attention control, memory, writing/typing, learning proficiency, self-confidence, self-worth, walking-running, depth perception, automobile driving, balance, eye-hand coordination, and virtually all athletic performance…of at least 70-80% of all students and adults to at least some significant degree. This is approximately the same percentage of students who struggle to proficiently read even their own grade-level textbooks.

Dyspraxia is considered a disability under the Americans with Disability Act (ADA), and therefore ALL schools (K-12, and Post-Secondary) that receive federal funds for Education are required to provide accommodations/funding for the detection, diagnoses, and treatment of Dyspraxia. Employers may also be required to provide accommodations for their employees with Dyspraxia.

However, Dyspraxia cannot legally be detected, diagnosed, or treated by educators, who are not state-licensed as qualified Healthcare Providers (collaborating Physicians, OT’s, and PT’s). Educators can be trained to function as “Aids” to state-licensed OT’s and PT’s, but schools need to contract with licensed Healthcare Providers, to legally detect, diagnose, and treat the accurately diagnosed students and adults.

Even though Dyspraxia is chronic and believed to be incurable, OT’s and PT’s know that patients’ brains can learn to work-around the inhibited brain-neural-motor-muscle connections, to facilitate better coordination between the brain and motor muscles of virtually all students and adults.

There is a need for new medical/healthcare technology and treatment that can be the center of a new Neural OT and PT Specialty that can enable IT OT’s and PT’s to successfully contract with K-12, and post-secondary schools to produce student, and adults, who proficiently read, study, and enjoy at least grade-level attention control, with less or without the use of drugs.

In light of the foregoing, disclosed herein are systems and methods for producing a spatialized audio signal that works in conjunction with hardware to track eye movement to enhance reading comprehension and attention control.

### BRIEF DESCRIPTION OF THE DRAWINGS

Non-limiting and non-exhaustive implementations of the disclosure are described with reference to the following figures, wherein like reference numerals refer to like or similar parts throughout the various views unless otherwise specified. Advantages of the disclosure will become better understood with regard to the following description and accompanying drawings where:

FIG. 1 is a schematic diagram of a user interacting with system having a software application for enhanced reading comprehension and attention control according to the principles of the disclosure;

FIG. 2 is a view of a computing device displaying text according to the principles of the disclosure;

FIG. 3A is a view of a schematic illustration of a user interacting with a software application for enhanced reading comprehension and attention control utilizing binaural audio;

FIG. 3B is a view of a schematic illustration of a user interacting with a software application for enhanced reading comprehension and attention control utilizing binaural audio;

FIG. 3C is a view of a schematic illustration of a user interacting with a software application for enhanced reading comprehension and attention control utilizing binaural audio;

FIG. 4A is a view of a schematic illustration of a user viewing a computing device according to the principles of the disclosure;

FIG. 4B is a view of a schematic illustration of a user viewing loss of attention on a computing device according to the principles of the disclosure;

FIG. 4C is a view of a schematic illustration of tracking a user’s attention across lines of text displayed on a computing device according to the principles of the disclosure;

FIG. 5A is a quiz screen displayed on a computing device according to the principles of the disclosure;

FIG. 5B is a view of a results screen displayed on a computing device according to the principles of the disclosure;

FIG. 5C is a view of a results graph screen displayed on a computing device according to the principles of the disclosure;

FIG. 6 is a view of a schematic illustration of a user interacting with a software application for enhanced reading comprehension and attention control utilizing binaural audio in a first alternate implementation according to the principles of the disclosure;

FIG. 7 is a view of a schematic illustration of a user interacting with a software application for enhanced reading comprehension and attention control utilizing binaural audio in a second alternate implementation according to the principles of the disclosure;

FIG. 8A is a view of a schematic illustration of a computing device displaying an attention control icon according to the principles of the disclosure;

FIG. 8B is a view of a schematic illustration of a user viewing a computing device displaying an attention control icon according to the principles of the disclosure;

FIG. 9A is a side view of a schematic illustration of a user interacting with a computing device and moving the computing device away from the user according to the principles of the disclosure;

FIG. 9B is a side view of a schematic illustration of a user interacting with a computing device and moving the computing device close to the user according to the principles of the disclosure;

FIG. 10A is a view of a schematic illustration of a user interacting with a computing device and having the computing device out of alignment with the user according to the principles of the disclosure;

FIG. 10B is a view of a schematic illustration of a user interacting with a computing device and having the computing device out of alignment with the user according to the principles of the disclosure;

FIG. 11 is a view of a schematic illustration of a near point distance measurement screen according to the principles of the disclosure;

FIG. 12 is a view of a schematic illustration of a self-guided reading options screen according to the principles of the disclosure;

FIG. 13 is a view of a user interacting with a software application for enhanced reading comprehension and attention control utilizing binaural audio in a self-guided reading exercise according to the principles of the disclosure;

FIG. 14 is a view of a journal screen displayed on a computing device according to the principles of the disclosure;

FIG. 15 is a view of an exemplary network diagram comprising a software application for enhanced reading comprehension and attention control according to the principles of the disclosure;

FIG. 16 is a view of an exemplary network diagram featuring a machine learning platform comprising a software application for enhanced reading comprehension and attention control according to the principles of the disclosure; and

FIG. 17 is a view of an exemplary network diagram of complementary hardware.

### DETAILED DESCRIPTION

Disclosed herein are systems and methods for producing a spatialized audio signal that works in conjunction with hardware to track eye movement to enhance reading comprehension and attention control. Also disclosed herein are systems and methods for coordinating digital visual content with dynamically controlled digital spatialized audio signals based on measured physiological interactions between a user and a computing device. In particular, the embodiments disclosed herein improve the operation of computing devices that present text by digitally measuring eye movement behavior, image data, and automatically modifying parameters of a spatialized stereo audio output in real time to synchronize with a user’s reading progression.

Unlike conventional reading assistance techniques that rely on static audio playback or manual user input, the disclosed techniques utilize real-time digital image processing of eye movement data captured by an image sensor and algorithmic modification of digital audio signal parameters, thereby providing a machine-driven feedback loop between visual gaze tracking and audio signal generation. The systems and methods rely upon the image sensor and digital sound playback via a stereo audio device to produce measurable improvements in synchronization, attentional monitoring, and adaptive reading guidance that cannot be achieved by human mental processes alone.

Before the systems and methods are disclosed and described, it is to be understood that this disclosure is not limited to the software and hardware configurations, method steps, and user interface elements disclosed herein as such software and hardware configurations, method steps, and user interface elements may vary somewhat. It is also to be understood that the terminology employed herein is used for describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the term “about” used in reference to a given parameter is inclusive of the stated value and has the meaning dictated by the context (e.g., it includes the degree of error associated with measurement of the given parameter).

As used herein, the terms “comprising,” “including,” “containing,” “characterized by,” and grammatical equivalents thereof are inclusive or open-ended terms that do not exclude additional, unrecited elements or method steps.

A detailed description of systems, methods, and devices consistent with embodiments of the disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for clarity, certain technical material that is known in the related art has not been described in detail to avoid unnecessarily obscuring the disclosure.

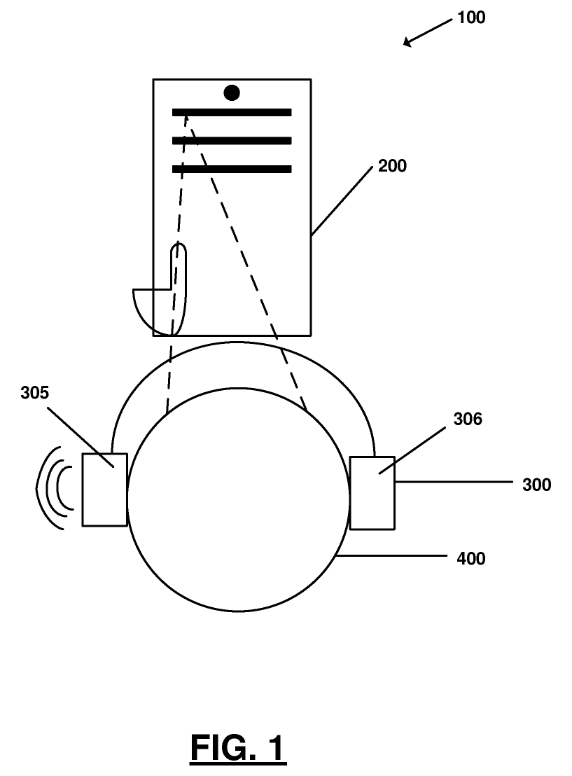

Referring now to the figures, FIG. 1 is a schematic diagram of a user interacting with system 100 for enhanced reading and attention control. The system 100 may comprise a computing device 200 and audio device 300 utilized by user 400. The system may be configured to guide a user through a series of exercises to help users increase reading proficiency and competence. It will be appreciated that the computing device 200 may be any computing device capable of running software, including but not limited to smartphones, tablet computers, desktop computers, laptops, and others. The computing device 200 may be connected to a network, such as an internet network, to provide access to an application running on the computing device 200. It will also be appreciated that audio device 300 may be any audio device capable of outputting stereo audio, including but not limited to headphones, earbuds, clip-on headphones, wireless earbuds, stereo speakers, and others. The audio device 300 may be referred to as an audio output device where first output 305 of the audio device 300 produces a first sound and second output 306 of the audio device 300 produces a second sound. The first output 305 and the second output 306 may be described as speakers. The software application may provide a user 400 with a variety of exercises intended to assist a user in multiple ways to ultimately enhance the user’s reading ability and attention control.

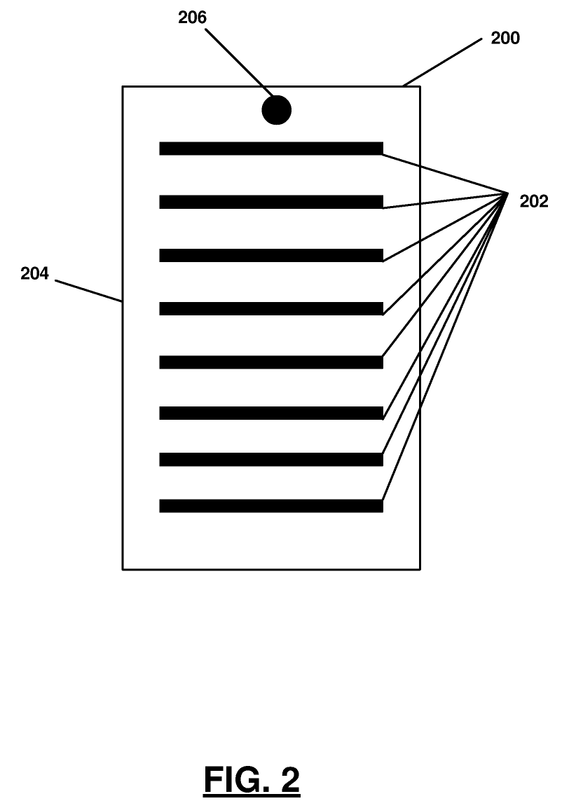

FIG. 2 shows a view of a schematic illustration of a computing device 200 of system 100 for enhanced reading comprehension and attention control according to the principles of the disclosure. A user may interact with a software application via a computing device 200. The computing device 200 may display text 202 on screen 204 during an exercise the screen 204 may be referred to as a display. The computing device 200 may further comprise camera 206 for capturing images or video of a user including image data, which will be elaborated upon further below. The image data may be digital and output by the camera 206 in a machine readable format. The camera 206 may be referred to as an image sensor. It should be appreciated that the schematic illustration in FIG. 2 represents text 202 as black bars in a horizontal, top-down configuration as would commonly be seen with European languages that read left-to-right word by word, and top-down line to line, as an exemplary implementation. The computing device 200 disclosed herein may, in some implementations, instead display text 202 in a right-to-left horizontal configuration on screen 204 as seen with languages like Hebrew or Arabic. In yet other implementations the computing device 200 may display text 202 in a vertical orientation that reads top-to-bottom word by word, and right-to-left line by line as seen in languages like Japanese. It will be appreciated that the software application disclosed herein is capable of displaying and operating with any and all known human languages, whatever organization those languages may feature.

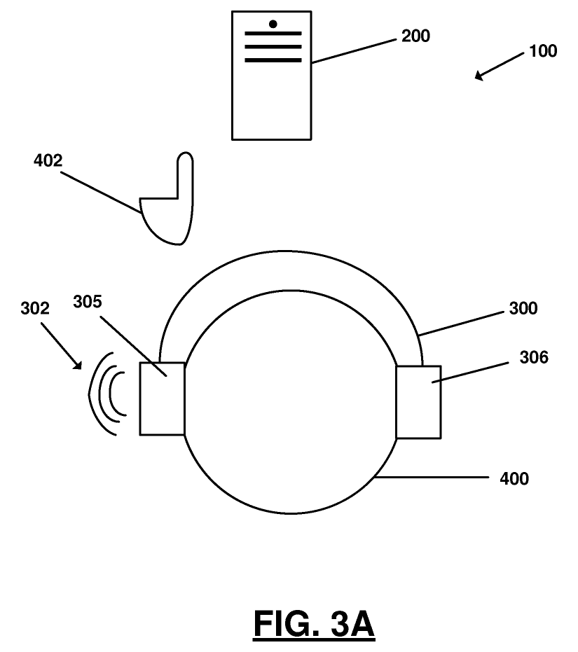

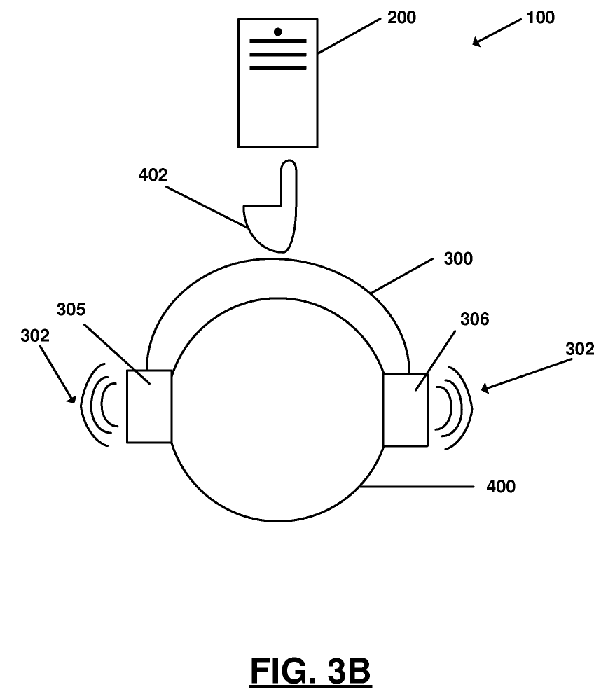

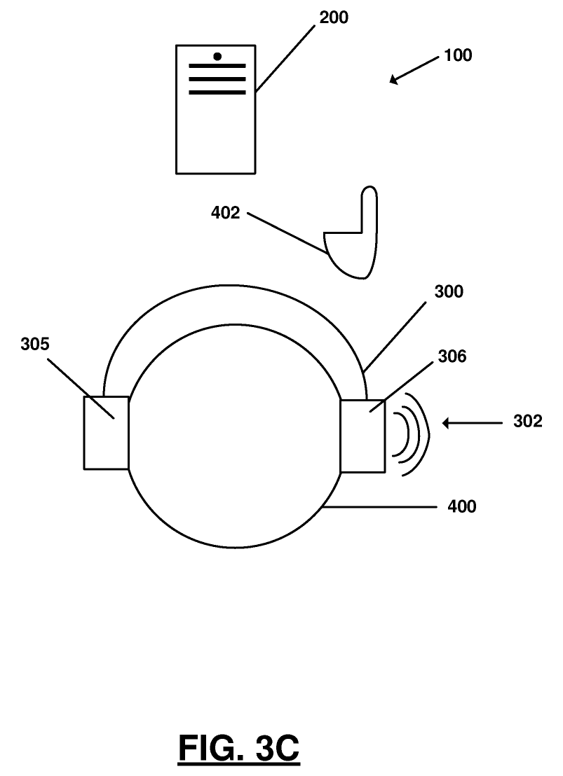

FIG. 3A shows a user 400 utilizing the system, including a stereo audio component, for enhanced reading comprehension and attention control according to the principles of the disclosure. In an implementation, a user 400 may utilize audio device 300 to listen to digital audio 302 during a reading exercise. Audio 302 may comprise a variety of sounds, including individual musical notes or tones, music, white noise, or other colored noise (e.g., pink noise or brown noise), an audio recording of text on the screen, or other audio. Audio 302 may comprise a unique sound having a sort of “shape.” The sounds or tones of the audio may be digital and may be modified before, during, or after playback. The shape of the sounds may be associated with the spatial location of the sound meaning that the sound may have an apparent or perceived location in a room such as left, central, or right. This audio is described in detail in U.S. Patent No. 5,033,966, “CYCLIC STEREOPHONIC SOUND PATTERN METHOD AND APPARATUS FOR READING IMPROVEMENT,” which is incorporated herein by reference. Computing device 200 may provide instructions to user 400 to use a hand 402 to “follow” the audio 302 produced by audio device 300. In an implementation where audio device 300 is a pair of stereo headphones, audio device 300 may initially produce sound from a left headphone of the pair of stereo headphones as illustrated in FIG. 3A. The computing device 200 may instruct user 400 to raise hand 402 to their left to “follow” the audio 302.

While the example illustration in FIG. 3A begins with an audio queue from a left side, such as first output 305, it will be appreciated that when used with a language that reads right-to-left, the system may first produce audio 302 from a left ear, first output 305, or side of audio device 300 and a user 400 may be instructed to raise a hand 402 to the user’s 400 left side.

It will be appreciated that the system may produce synesthetic-style effects, in which stimuli in one sensory domain (e.g., audio) are algorithmically mapped to outputs in a different sensory domain (e.g., visual), without implying any neurological condition.

As the audio 302 continues, the audio 302 may emit from both ears or sides, first output 305 and second output 306, of audio device 300 thus “centering” the audio from the perspective of user 400, as shown in FIG. 3B. The computing device 200 may instruct user 400 to raise a hand 402 in front of the user 400. A user 400 may then experience audio 302 produced by a right ear or side, second output 306, of audio device 300 and be instructed by computing device 200 to move their hand 402 to a right side of user 400 as shown in FIG. 3C. As the user 400 reads text displayed on computing device 200, the user may be instructed by computing device 200 to “follow” audio 302 with their hand 402, or one or more fingers of their hand 402, from left to right in front of them as audio 302 “moves” left-to-right or vice-versa through audio device 300. It should be appreciated that while FIG. 3C appears to show hand 402 moving with an index finger extended, a user may follow audio 302 with any finger of their hand 402. Those of ordinary skill will also appreciate that a user 402 could follow audio 302 with any suitable pointing implement. The shape of the sound that moves from left to center to right, or any other orientation, may be described as spatialized audio signal that transitions between a first spatial position to a second spatial position over time. The first spatial position and the second spatial position may be perceived locations or positions relative to where the first and second sound are located. The spatialized audio signal may move at a speed or first rate according to a predefined reading progression. The predefined reading progression may be a default progression or may be based on a rate associated with a given user. The predefined reading progression may be a based on a measured reading speed for a given user.

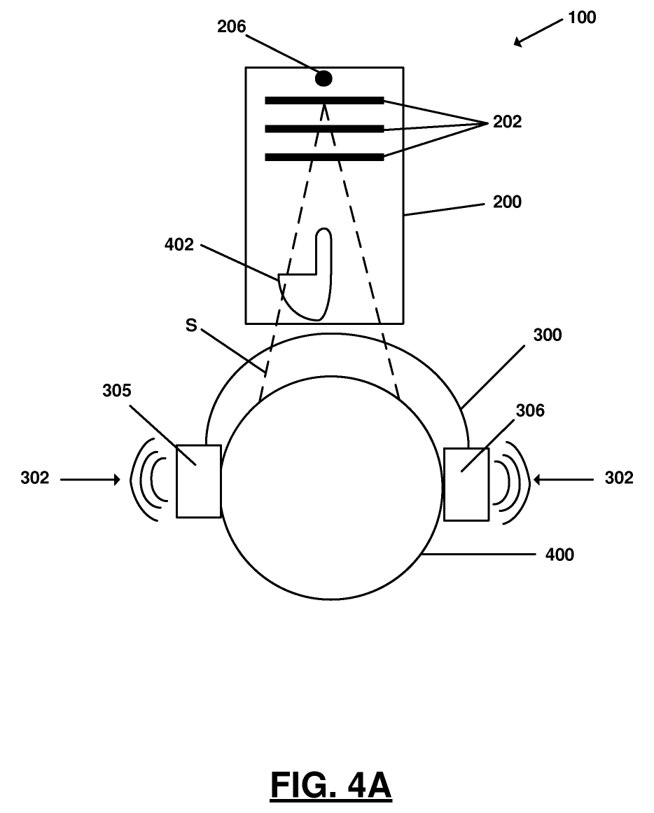

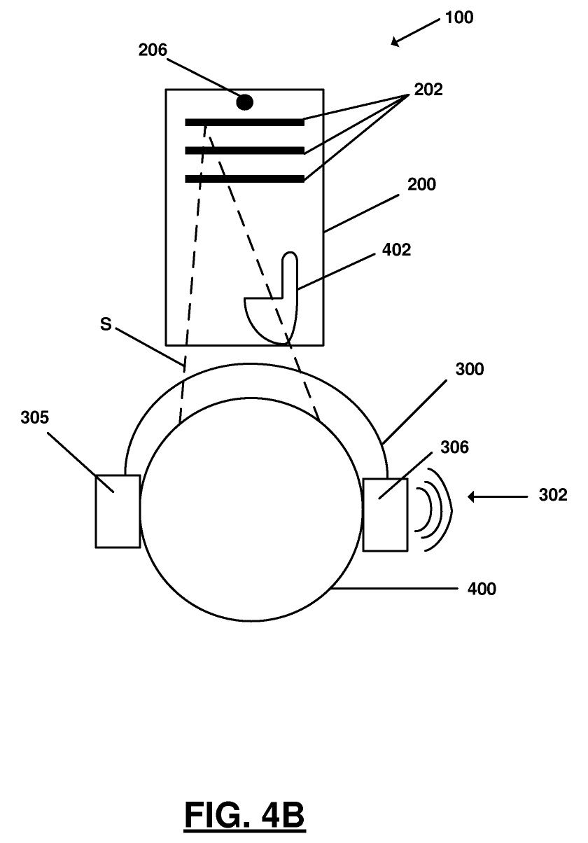

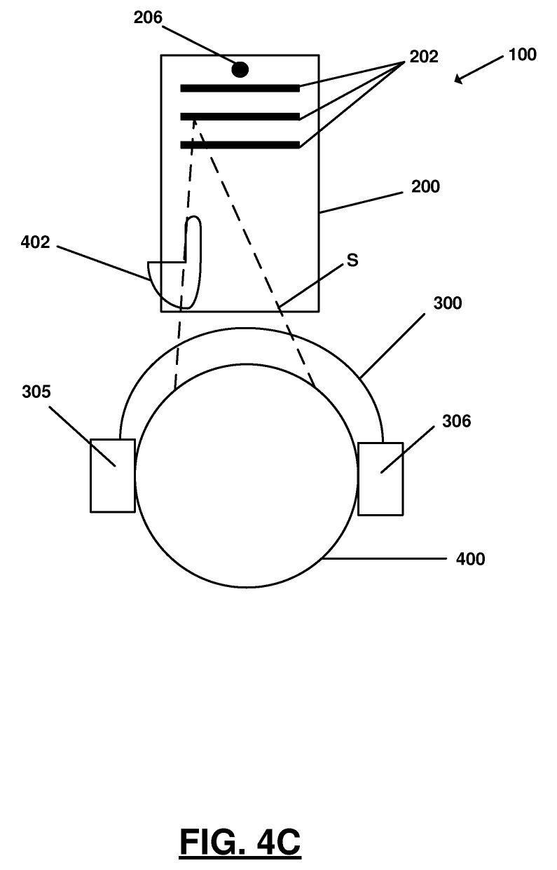

FIG. 4A shows a schematic illustration of a user 400 engaging with system 100 and having their vision monitored with camera 206 of computing device 200. In some implementations a user 400 may be monitored by camera 206 of computing device 200 while reading text 202 displayed on computing device 200. As user 400 reads text 202 on computing device 200, camera 206 may capture images or video to detect user 400’s eye movements. The line of sight of user 400 is represented in FIG. 4A as line-of-sight S. The camera 206 may be in communication with audio device 300 such that the camera 206 “knows” where a user 400’s eyes should be relative to the audio 302 produced by audio device 300. For example, if audio 302 is only coming out of a left side of audio device 300, the system 100 would be aware that camera 206 should detect user’s 400 vision S on a left side of a line of text 202.

In some instances, a user may become distracted and reduce attention control on text 202. In such instances a user’s 400 line-of-sight S may “regress” and look back to previous words in a line of text 202, as shown in FIG. 4B. Text 202 may contain approximately the same number of letters and words per line, such that user 400 may be able to read each line within the same number of seconds or fractions of a second. Over time, a user 400’s eyes may make near-zero regressive eye movements consisting of “look backs” or small right to left eye movements to help user 400 improve their attention control. There will be a large right-to-left eye movement, which the user 400 makes, at the end of each line of the passage of text 202, as shown in FIG. 4C. The system 100 may be capable of detecting and differentiating between right-to-left eye movement “regressing” to an earlier point in a line and right-to-left eye movement from a user 400 advancing to a subsequent line of text 202.

A user’s attention control level is inferred by a standard deviation of a user’s measured line reading rate. The line reading rate may be referred to as a reading rate or reading speed. As a user reads each line of a passage during a reading exercise, the camera 206 of the computing device 200 may measure the amount of time that a user’s eyes spend reading each line, left-to-right, to the end of each line. Once a user’s eyes have moved back, right-to-left, to the beginning of each new line, computing device 200 may again measure the amount of time the user spent reading each of the remaining lines.

If the user momentarily loses attention control, the user may quickly move their eyes to look backward (moving right-to-left) to re-read what the user missed upon losing attention control. As measured time to read each line becomes more equal, the system can determine that a standard deviation of line-per-line reading time declines, which infers that the user’s attention control is increasing.

Standard deviation is a statistical measure of variability that indicates the average amount that a set of numbers deviates from their mean. The higher the standard deviation, the more spread out the values, while a lower standard deviation indicates that the values tend to be close to the mean. The standard deviation discussed herein relative to line-reading time is calculated by measuring the differences in the amount of time spent reading each line of the 100-word passage and comparing those differences to each other. Thus, a user’s standard deviation can objectively infer the user’s level of attention control. As the user’s standard deviation toward zero, the system can determine the user’s attention control is improving.

In one implementation, concurrent with displaying the text, the computing device 200 may output a first digital audio signal to the first output 305 of the stereo audio output device and a second digital audio signal to the second output 306. The first and second audio signals together generate a spatialized audio signal perceived as transitioning from a first spatial position to a second spatial position over time.

The transition from the first spatial position to the second spatial position can occur at a first rate corresponding to a predefined reading progression. This rate is implemented by controlling digital audio parameters such as relative amplitude, phase offset, delay, or filtering between the first and second audio signals.

Based on the measured reading rate of the user 400, derived from the digital image data from the camera, the processor can modify the rate of the spatialized audio transition from the first rate to a second rate. This modification is performed automatically by the processor and causes the perceived spatial position of the audio signal to remain synchronized with the user’s actual reading progression along the text. It should be appreciated that the spatialized audio may transition to a different rate any number of times while the user is reading the text. The transitions may be performed in real-time and may be synchronized with the image data from the image sensor, such as the camera 206.

In one implementation, the spatialized audio may transition to a rate defined by or selected by the user such as a target reading rate. In one implementation, the spatialized audio may transition to a predicted rate that is predicted by the computing device 200. The predicted rate may predict what the reading speed of the user is going to be based on historical data.

In some implementations, the spatial position of the audio signal corresponds to a relative position along a line of text, thereby forming a multimodal synchronization mechanism between visual gaze position and perceived audio location.

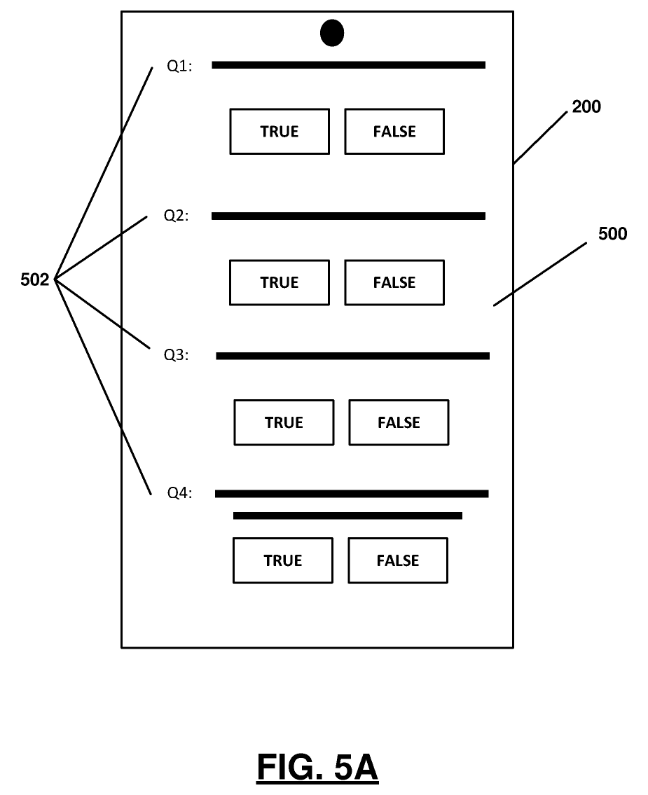

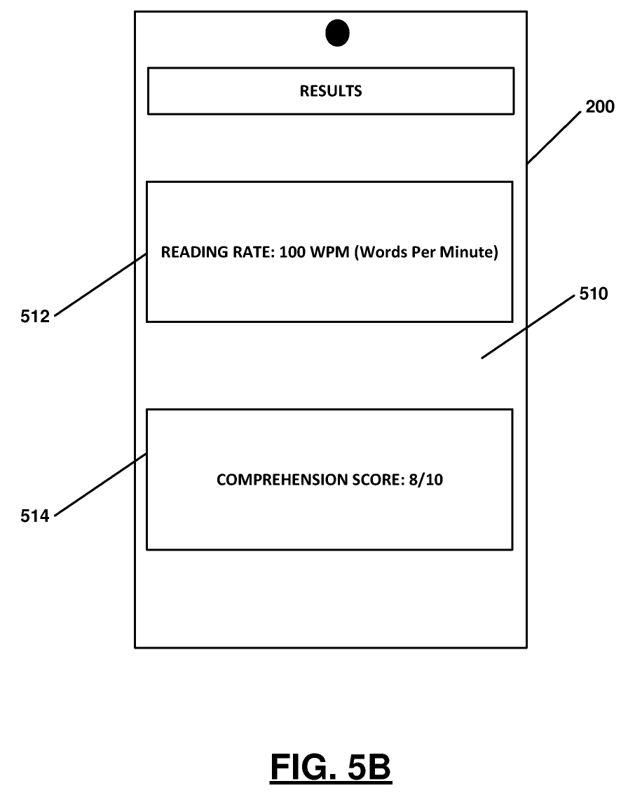

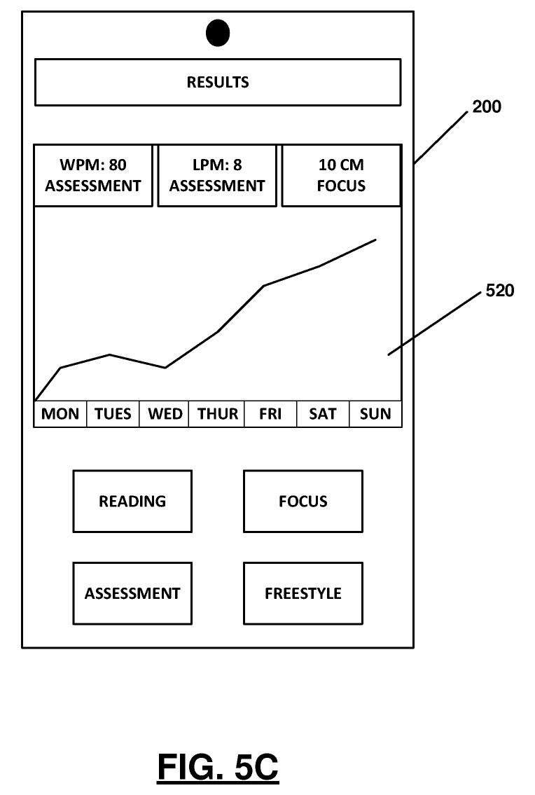

Following completion of a reading exercise, a computing device 200 may present to the user a series of questions 502 on a quiz screen 500 about the passage read, as illustrated in FIG. 5A. In some implementations the questions 502 may be TRUE or FALSE questions, while in other implementations the questions may be “fill in the blank” questions, short essay questions, or other types of questions intended to measure reading comprehension. The computing device 200 may store information relating to how many questions a user answered correctly as part of an overall assessment of reading comprehension of the passage the user just read.

Computing device 200 may also show a results screen 510, as illustrated in exemplary FIG. 5B. The screen may show a reading rate 512 of how many words a user read per minute during the reading exercise. The screen shown in 5B may also display a score 504 pertaining to the number of questions answered correctly a user following completion of a reading exercise. In some implementations the screen of FIG. 5B may also show a measure of a user’s standard deviation of how often a user’s eyes “regressed” or look backwards within a line. The computing device 200 is able to distinguish between a user’s eyes regressing to re-read a section of text as opposed to a user’s eyes moving back, meaning moving right-to-left, to advance to reading a next line of text on the display. This distinction may be made by evaluating characteristics of the backward gaze movement, including magnitude, duration, and statistical variance. For example, short backward movements with low variance may indicate line advancement, whereas longer backward movements with higher variance may indicate re-reading. These determinations are performed algorithmically using digital image data and are not reliant on subjective interpretation.

FIG. 5C shows a results graph screen of a software application for enhanced reading comprehension and attention control according to the principles of the disclosure. Once a user completes a number of reading exercises, computing device 200 may be able to display a results graph 520 plotting gains or losses of various measurements tracked by the system 100. Computing device 200 may display a graph showing increases or decreases in measured words-per-minute (WPM), lines-per-minute (LPM), or other measures.

All exercise data may appear and be graphed on the results graph 520. Users typically find themselves self-motivated to complete daily exercises if they are able to visualize their progress. In some implementations the system 100 may provide alerts, to remind users to engage in an exercise if they have not done so for a particular day. Depending on the implantation, these exercises may take a user around 10 minutes to complete.

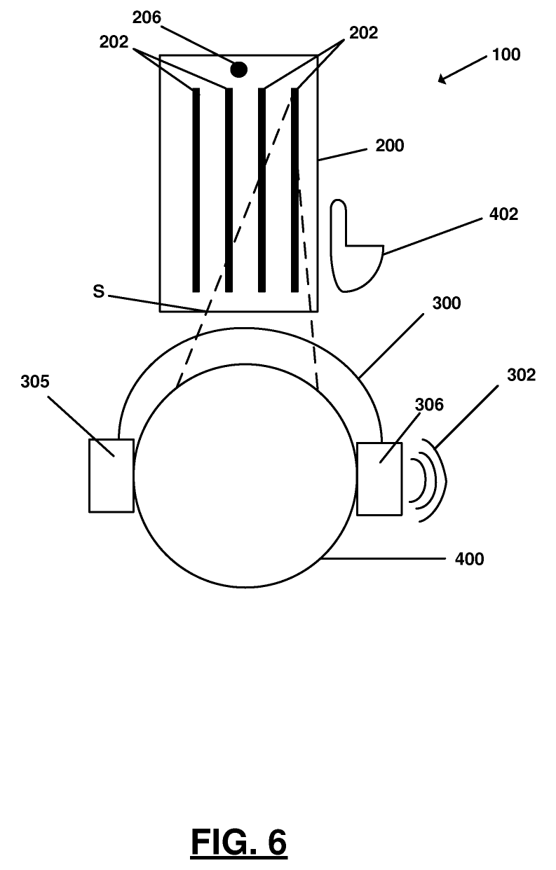

FIG. 6 shows an exemplary implementation of system 100 configured for use with a language other than one that may follow a left-to-right, top-to-bottom flow of European languages like English. In some implementations, like the one shown in FIG. 6, the computing device 200 may display text 202 may display text 202 in a vertical orientation that reads top-to-bottom word by word, and right-to-left line by line as seen in languages like Japanese. In such implementations, audio 302 may be emitted from audio device 300 in a top-to-bottom manner word by word, and in a right-to-left manner, line by line. A user 400 may “follow” the audio 302 with a hand 402 similarly in a top-to-bottom, right-to-left manner. Those skilled in the art will appreciate that a right-to-left horizontal configuration of text 202 that could support languages like Hebrew or Arabic is also contemplated within the scope of the disclosure. In yet other implementations system 100 is capable of displaying and operating with any and all known human languages, whatever organization style those languages may feature.

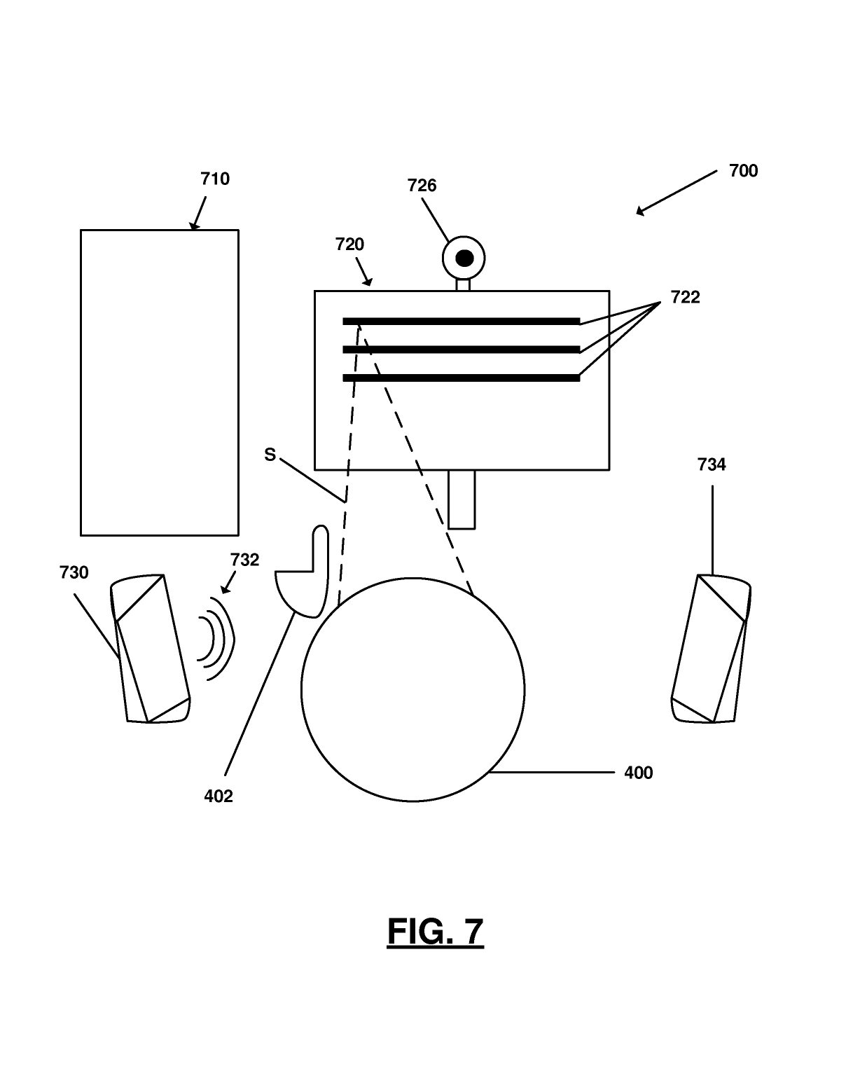

FIG. 7 shows an alternate implementation of a system 100 according to the principles of the disclosure. Figures up to now have shown computing device 200 as a device resembling a portable device like a smart phone or tablet. In some implementations, a user 400 may engage with software for enhanced reading comprehension and attention control on a different type of computing device, shown in exemplary FIG. 7 as desktop computer system 700 including tower 710 with a processor and memory and a display 720 to display text 722. In such a configuration, a user may utilize a stereo audio output device as external stereo speakers. For example, speaker 730 may be a first output device outputting first sound 732 and speaker 734 may be a second output device. while a user’s 400 vision is monitored by an image sensor such as a webcam 726 or similar camera device. Those of ordinary skill will appreciate that this figure and arrangement of components is merely illustrative and other computing hardware and hardware arrangements are within the scope of this disclosure.

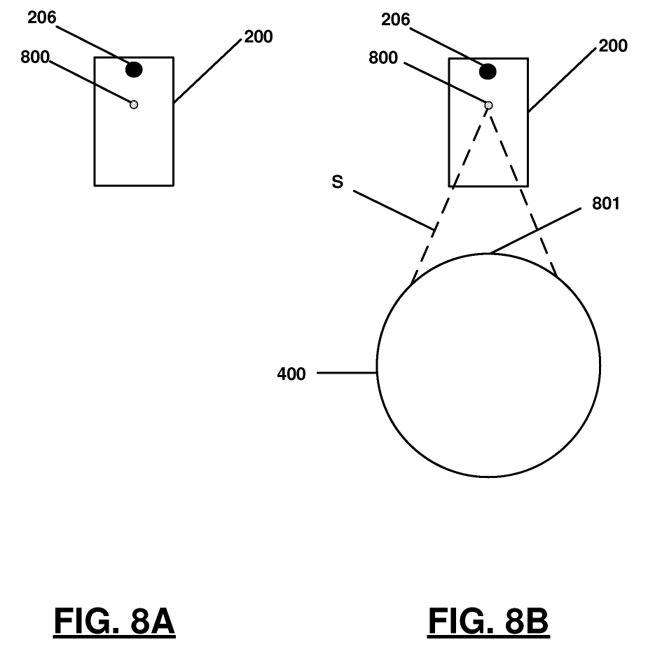

FIG. 8A shows a computing device 200 displaying an icon 800 according to the principles of the disclosure. In some implementations, a software application for enhanced reading comprehension and attention control may provide an icon 800 to assist in user 400 attention control. In some implementations computing device 200 may direct user 400 to direct their vision to the icon 800, where the user’s 400 line-of-sight S is detected by camera 206.

The system 100 may be able to measure the distance that a user 400 is able to bring icon 800 close the center of the bridge 801 of the user’s 400 nose while maintaining one single image of icon 800. The measure of this distance can infer user’s 400 current Binocular Convergence Deficiency (BCD), if any. BCD’s are seldom, if ever detected or measured, yet they tend profoundly inhibit an individual’s reading rate, comprehension, and attention control, and they also inhibit individuals’ ability to hit, catch, or kick a ball. BCDs inhibit depth perception, which inhibits walking, running, dancing, using stairways, all without tripping, and safely and confidently driving vehicles confidently, especially after dark.

It is not uncommon for individuals to have an undetected BCD, of ¾ inch, or more. A ¾ inch BCD could mean that the left-eye is reading word #1 of a line, while the right eye is reading word #2 or #3, depending on the relative size of the type font; the smaller the type font, the more confusing it could be. This disparity can cause confusion, and the brain will attempt to resolve this confusion which reduces reading rate, comprehension, and memory while it concurrently increases the probability of Attention Deficits and headaches. Many individuals also unknowingly suffer with Over-Binocular Convergence, aka, cross eyed, which tends to be even more inhibiting.

Individuals with larger BCD’s will tend to develop reading characteristics that are similar to those who have dyslexia, and they also tend to also be less and less proficient as athletes. These individuals will also tend to experience more occupational and driving accidents, because they suffer from adequate depth perception, while the best athletes enjoy near-perfect Binocular Convergence, and much more personal confidence.

To aid users in treating BCD, the system 100 may provide one or more exercises with the intent of strengthening fine muscles of a user’s eyes. Shown in FIG. 8B, such exercises may begin by having a user 400 train their attention on icon 800. Camera 206 may capture images or video to determine whether user 400 is keeping their line-of-sight on icon 800.

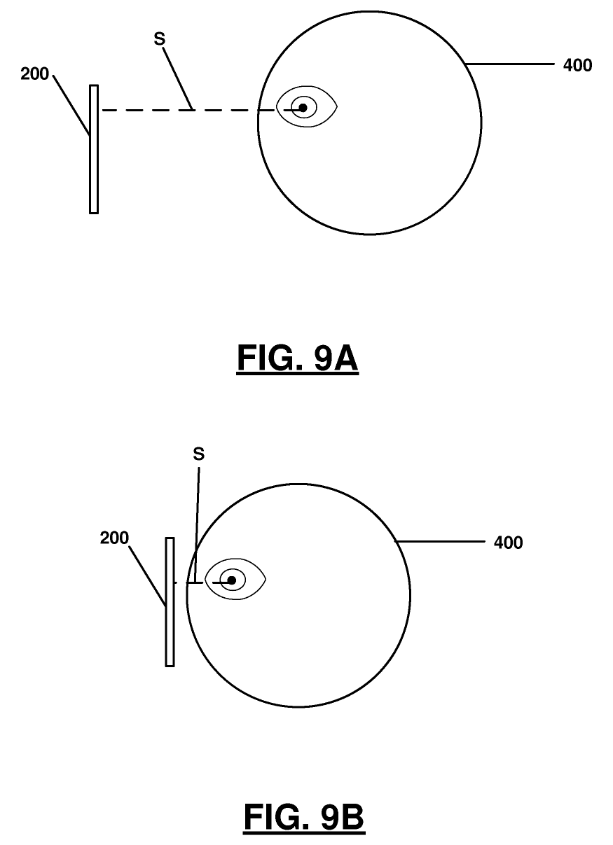

To begin the exercise, computing device 200 may direct users to hold computing device 200 in their hand, with their arm fully extended as shown in FIG. 9A. Once extended, computing device 200 may instruct a user 400 to train both eyes on the icon 800. While observing icon 800, a user 400’s perspective may cause an appearance of more than one icon 800. If so, computing device 200 may instruct user 400 to adjust positioning of computing device 200 such that there is only icon 800 and no more than one.

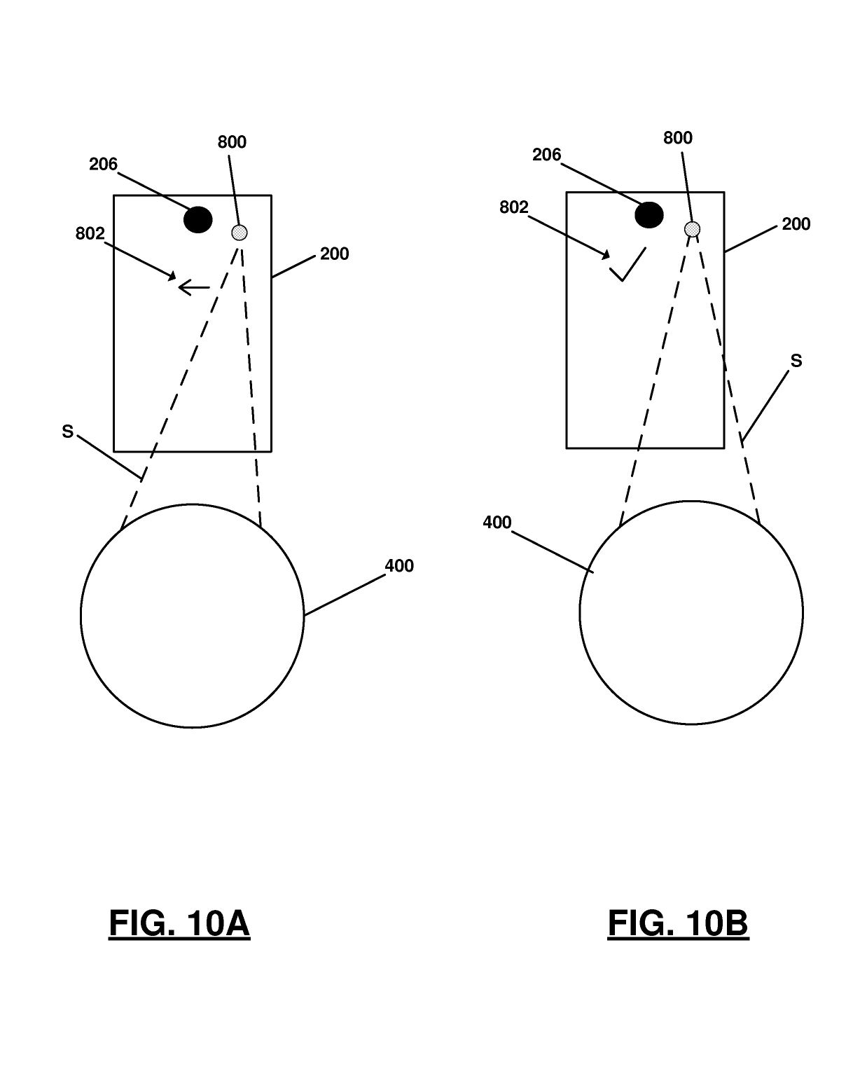

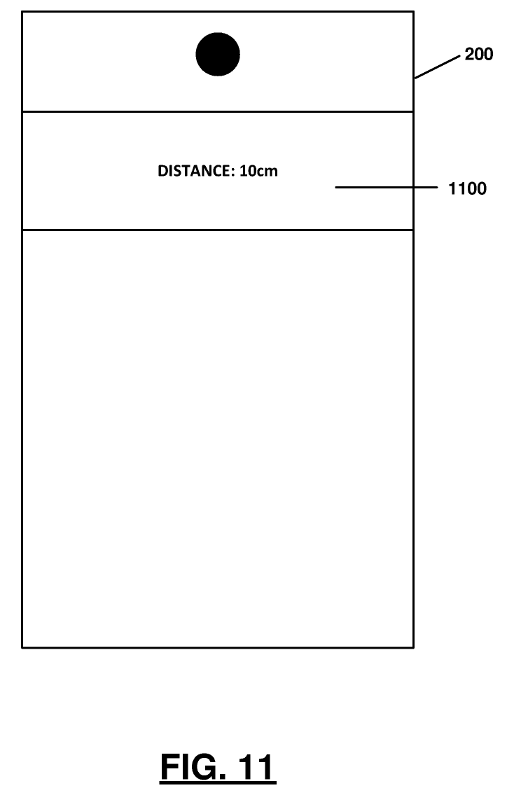

Next, computing device 200 may instruct user 400 to slowly move computing device 200 toward user’s face, as shown in FIG. 9B. While moving computing device 200 toward their face, computing device 200 may instruct the user 400 to ensure that icon 800 remains clear in a user’s 400 vision. While drawing the icon 800 to their face, the user 800 may be directed to move computing device 200 to in some way, as illustrated in FIG. 10A. The user 400 may be instructed to adjust computing device 200 to the left or the right or up or down relative to user 400’s point of view so that icon 800 is being drawn directly to the center of the bridge of the user’s 400 nose. An instruction to adjust computing device 200 may take the form of secondary icon 802. Secondary icon 802 may comprise a visual indicator on when and how to adjust computing device 200. In the exemplary implementation of FIG. 10A, secondary icon 802 is an arrow directing user 400 to adjust computing device 200 to the user’s 400 left. In exemplary FIG. 10B, user 400 has adjusted computing device 200 adequately, causing secondary icon 802 to change to a positive indicator that the adjustment was adequate. Some users with a “lazy-eye” or are “cross-eyed,” or suffering from a similar eye impairment, may be repeatedly directed to move the computing device 200 in some way since the icon 800 will naturally be drawn to the dominate eye.

The user 400 may be instructed to continue moving computing device 200 closer and closer to their face until the user 400 can no longer keep icon 800 in focus. The distance at which the user can no longer keep icon 800 in focus may constitute a “near point.” When a user reaches a “near point,” the user may be instructed to conclude the lesson until a later time. In subsequent exercises, a user may improve their “near point” and be able to keep icon 800 in focus when computing device 200 is at a closer distance to user 400’s face. The computing device 200 may provide warning instructions to users that they can hurt the muscles of their eyes if they try to draw the icon 800 or computing device 200 display closer to their face than a current “near point” that user 400 is acclimated to.

A “near point” is the distance from icon 800 on the screen of computing device 200 to the bridge of a user’s nose. It’s the distance from the user’s nose, where the user can no longer keep icon 800 in focus. It’s where the icon 800 is as close to the bridge of user’s nose, that a user can still see just one icon and no more than one.

A user’s “near point” distance infers the magnitude of any Binocular Convergence Deficiency that a user may be experiencing, not unlike 70-80% of all readers. Vision experts say that approximately 2 cm is “normal.” A 2 cm Binocular Convergence Deficiency means that the left eye may be seeing and reading the first word on a line, while the right eye may be seeing and reading the 2^{nd}, 3^{rd}, or 4^{th} word on the line.

To aid users in treating BCD, the system 100 may provide one or more exercises with the intent of strengthening fine muscles of a user’s eyes. Computing device 200 may instruct students to “bounce” or alternate computing device 200 between some farther distance and some closer distance relative to the user’s 400 face. Computing device 200 may instruct users to alternate between distances similar to those shown in exemplary FIGS. 9A and 9B. The system may instruct user 400 to repeat this “bounce” gesture multiple times over a time period.

Computing device 200 may display a user’s 400 “near point” measurements, and the number of times the user 400 was directed to move computing device 200 (which can infer “lazy eye” conditions), on a results screen as seen in FIG. 11.

FIG. 10A In some implementations icon 102 may not be displayed center to computing device 100, as shown in FIGS. 10A-10B. In some implementations, icon 102 may be displayed to another portion of the screen, such as a side, top, bottom, or upper corner or lower corner, or another portion of the display. As the user 300 moves computing device 100 closer or further away from their face, the computing device 100 may additionally instruct user 300 to keep computing device 100 center relative to a user 300’s nose.

If computing device 100, via camera 108, detects that user 300’s face has moved out of alignment with icon 102, the computing device 100 may display secondary icon 110, which may comprise some sort of graphic like an arrow or similar symbol to instruct user 300 to move computing device 100 back into alignment with their face, as shown in FIG. 6A. Once aligned, secondary icon 110 may change to another symbol to indicate user 300 has aligned computing device 100 adequately, as shown in FIG. 6B.

Users with a “Lazy-Eye” or “Cross-eye” may receive multiple directional messages to move their computing device to their left or to their right, so the icon is being pulled directly toward the center of the student’s nose.

Without the directional messages, the icon would naturally be pulled toward the dominate eye, rather than toward the center of the nose. By requiring the icon to be pulled up directly to the center of the nose, the user is teaching their eyes to overcome their Lazy-Eye and Crossed-Eye conditions. It is recommended that users do not attempt to pull the computing device closer to their face than the “near point,” as doing so could potentially harm the six muscles of each eye which are responsible for moving your eye, left-to-right, up-and-down, and diagonally.

The system 100 both detects and helps readers to rapidly overcome both Lazy-Eye and Cross-Eye conditions, depending largely upon the student’s commitment to practicing exercises shown in FIGS. 9A-9B. Users may consider encaging in the exercise in “sets,” and performing multiple sets a day, with at least an hour of rest between each set.

A user’s 400 near-point distance information may appear on a result screen displayed on computing device 200. The result screen may record your last recorded “near point,” a list of previously recorded near points, averages of near points, the number of “adjustments” needed in a particular exercise, and other similar information 1100. This information may also be included in the results graph screen shown in FIG. 5C

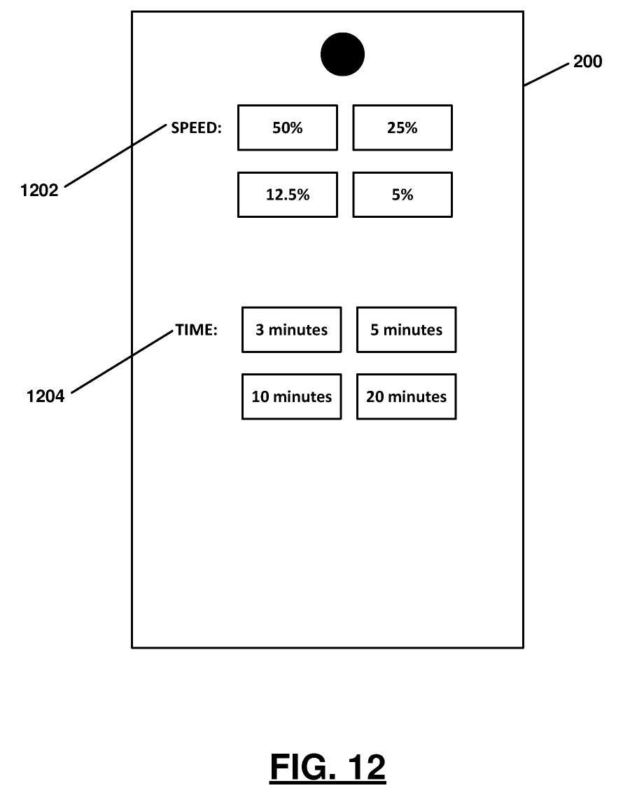

In some implementations a system 100 may comprise a guided self-reading exercise. This guided self-reading exercise may prompt a user to select a desired speed and time or target reading speed, as seen in FIG. 12. The desired speed 1202 or target speed option may be presented to the user as a text input or buttons, depending on the implementation. The user may be prompted to input or select a particular speed measured in Words Per Minute (wpm) or as a percentage, where the percentage represents an increase relative to a Words Per Minute count achieved by a user from a user’s previously recorded exercise. The time 1204 may prompt a user to input a time or select from a list of options. The time 1204 gives users a period of time during which they are expected to read. Time 1204 may represent a contiguous period of time for the whole exercise or represent a duration of a “round,” where the exercise may comprise a plurality of rounds.

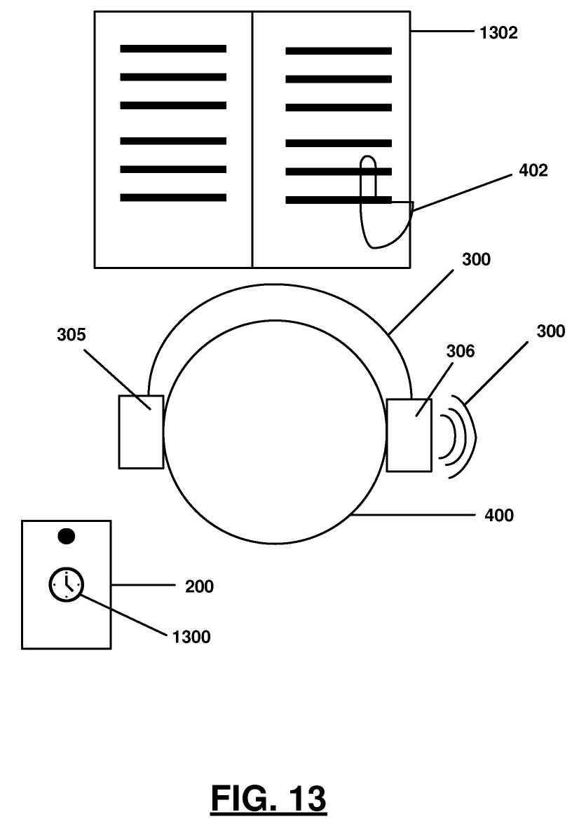

Once the exercise begins, the selected time converts to a countdown timer 1300, shown on computing device 200 in FIG. 13. User 400 is encouraged to read a book 1302 or other reading item of their choosing while computing device 200 displays countdown timer 1300. Countdown timer 1300 may countdown from a total amount of time selected by user 400 on a previous screen in some implementations. In other implementations, the countdown timer 1300 may count down over a number of rounds, where the time selected by user 400 in a previous screen represents an amount of time per round. During the countdown, audio device 300 will produce an audio 302 in accordance with the selected speed from the previous screen. For example, if a user selected “50% speed” or another speed increase, such as 12.5%, then the audio 302 may “pan” from one ear to another at a Words Per Minute speed 50% higher (or another speed higher, such as 12.5% higher) than a user’s 400 previously recorded best Words Per Minute reading speed. If a user 400 selects a specific Words Per Minute speed, the audio 302 will “pan” according to that speed.

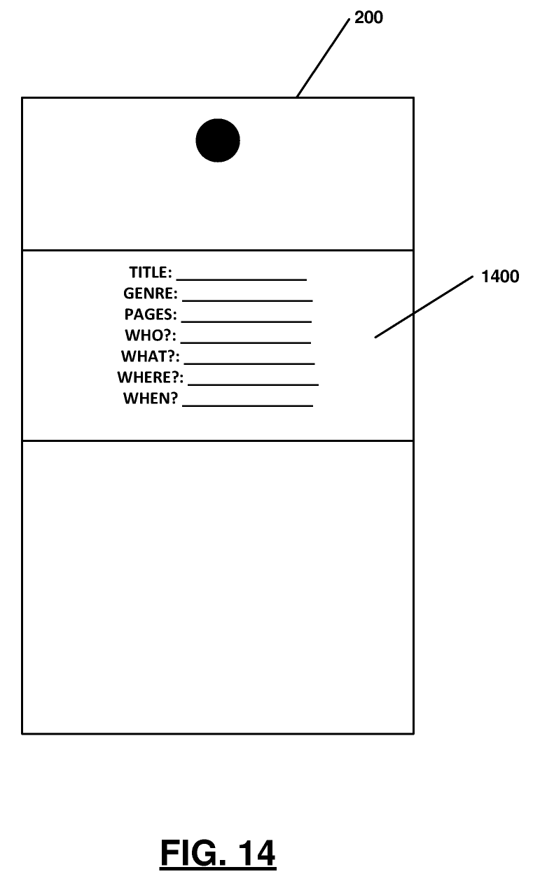

After the countdown timer expires, the self-guided reading exercise may prompt a user to input information about what they just read, shown in FIG. 14. Journal screen 1400 may prompt a user to input information about their reading in order to stimulate reading comprehension. In the exemplary figure, the user is prompted to input information about the title, genre, and pages read whatever they read. Also in the exemplary figure, users are prompted to answer questions like “WHO?” or “WHERE?,” as in, “WHO” was important in the passage just read? “WHERE” were the figures in the reading, or “WHERE” were they going? Those of ordinary skill will appreciate that these examples are merely examples and are nonlimiting, and that other prompting questions are contemplated by the disclosure.

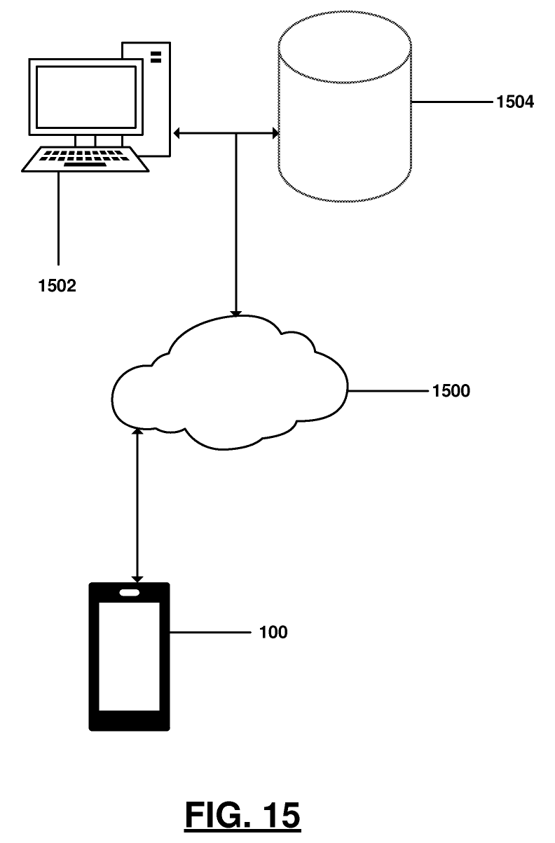

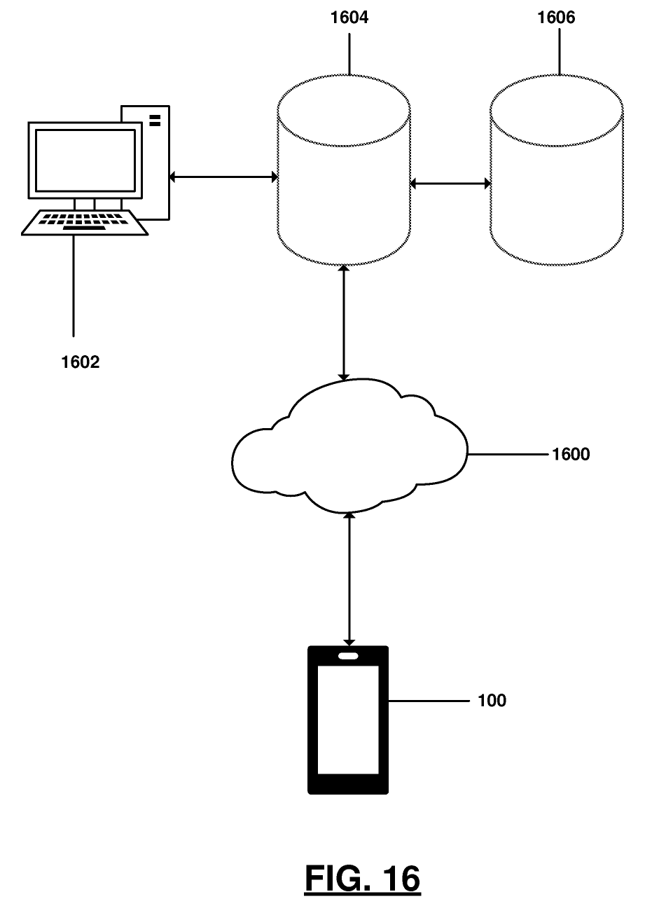

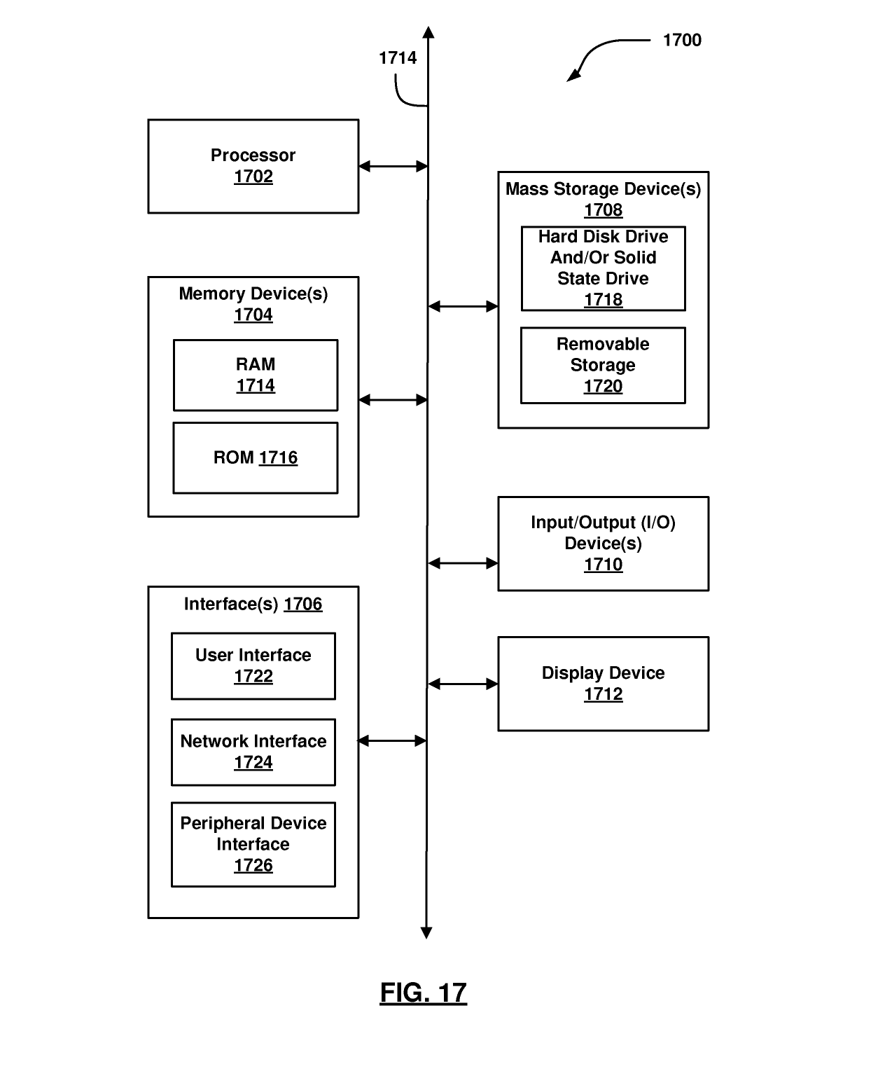

FIG. 15 shows a schematic illustration of an exemplary network diagram of a system according to the disclosure. In some implementations the results information collected from a user’s exercises may be saved locally to computing device 200. In other implementations a user’s device 200 may be connected to a network and may transmit information over that network to be saved to a server. FIG. 15 shows such an implementation with system 100 being in connection to a cloud 1500. Also connected to the network are network computer 1502 and network storage 1504. In an implementation, a user may participate in the exercises described herein and upload their results to a server managed by an instructor. The instructor may be able to review all user’s results and consider additional instruction accordingly. In other implementations a user may upload results information to a server managed by a company, which stores users results for archival and backup purposes.

In some implementations, users may upload results information over a cloud network including an Artificial Intelligence and/or Machine Learning (AI/ML) platform, as shown in FIG. 17. A user may upload information from system 100 over cloud 1600. Also connected to cloud 1600 is storage computer 1602 and server storage 1604, in communication with AI/ML platform 1606. The AI/ML platform 1606 may have access to user information and may be able to analyze results uploaded thereto. The AI/ML platform may be able to provide reading recommendations or other guidance based on the analyzed results.

FIG. 17 is a schematic diagram of complementary system hardware such as a special purpose computer, general-purpose computer, smartphone, or other computing device. Implementations within the scope of the disclosure may also include physical and other non-transitory computer readable media for carrying or storing computer executable instructions and/or data structures. Such computer readable media can be any available media that can be accessed by a general purpose or special purpose computer system. Computer readable media that stores computer executable instructions are computer storage media (devices). Computer readable media that carry computer executable instructions are transmission media. Thus, by way of example, and not limitation, implementations of the disclosure can comprise at least two distinctly different kinds of computer readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer executable instructions or data structures and which can be accessed by a general purpose or special purpose computer.

A “network” is defined as one or more data links that enable the transport of electronic data between computer systems and/or modules and/or other electronic devices. In an implementation, a sensor and camera control unit may be networked to communicate with each other, and other components, connected over the network to which they are connected. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer executable instructions or data structures and which can be accessed by a general purpose or special purpose computer. Combinations of the above should also be included within the scope of computer readable media.

Further, upon reaching various computer system components, program code means in the form of computer executable instructions or data structures that can be transferred automatically from transmission media to computer storage media (devices) (or vice versa). For example, computer executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered storage, such as FusionIO). Thus, it should be understood that computer storage media (devices) can be included in computer system components that also (or even primarily) utilize transmission media.

Computer executable instructions comprise, for example, instructions and data which, when executed by one or more processors, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, control units, camera control units, hand-held devices, hand pieces, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above-mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) or field programmable gate arrays (FPGAs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

FIG. 17 further a block diagram illustrating an example computing device 1700, which may relate to computing device 100 of FIG. 1, computing device 1100 of FIG. 11, or other similar and comparable computing devices. Computing device 1700 may be used to perform various procedures, such as those discussed herein. Computing device 1700 can function as a server, a client, or any other computing entity. Computing device 1700 can perform various monitoring functions as discussed herein, and can execute one or more application programs, such as the application programs described herein. Computing device 1700 can be any of a wide variety of computing devices, such as a desktop computer, a notebook computer, a server computer, a handheld computer, camera control unit, tablet computer and the like.

Computing device 1700 includes one or more processor(s) 1702, one or more memory device(s) 1704, one or more interface(s) 1906, one or more mass storage device(s) 1708, one or more Input/Output (I/O) device(s) 1710, and a display device 1912 all of which are coupled to a bus 1714. Processor(s) 1702 include one or more processors or controllers that execute instructions stored in memory device(s) 1704 and/or mass storage device(s) 1708. Processor(s) 1702 may also include various types of computer readable media, such as cache memory.

Memory device(s) 1704 include various computer readable media, such as volatile memory (e.g., random access memory (RAM) 1714) and/or nonvolatile memory (e.g., read-only memory (ROM) 1716). Memory device(s) 1704 may also include rewritable ROM, such as Flash memory.

Mass storage device(s) 1708 include various computer readable media, such as magnetic tapes, magnetic disks, optical disks, solid-state memory (e.g., Flash memory), and so forth. As shown in FIG. 17, a particular mass storage device is a hard disk drive 1718. Various drives may also be included in mass storage device(s) 1708 to enable reading from and/or writing to the various computer readable media. Mass storage device(s) 1708 include removable media 1920 and/or non-removable media.

I/O device(s) 1710 include various devices that allow data and/or other information to be input to or retrieved from computing device 1700. Example I/O device(s) 260 include digital imaging devices, electromagnetic sensors and emitters, cursor control devices, keyboards, keypads, microphones, monitors or other display devices, speakers, printers, network interface cards, modems, lenses, CCDs or other image capture devices, and the like.

Display device 1712 includes any type of device capable of displaying information to one or more users of computing device 1700. Examples of display device 280 include a monitor, display terminal, video projection device, and the like.

Interface(s) 1706 include various interfaces that allow computing device 1700 to interact with other systems, devices, or computing environments. Example interface(s) 1706 may include any number of different network interfaces 1724, such as interfaces to local area networks (LANs), wide area networks (WANs), wireless networks, and the Internet. Other interface(s) include user interface 1722 and peripheral device interface 1726. The interface(s) 1706 may also include one or more user interface elements 1722. The interface(s) 1706 may also include one or more peripheral interfaces such as interfaces for printers, pointing devices (mice, track pad, etc.), keyboards, and the like.

Bus 1714 allows processor(s) 1702, memory device(s) 1704, interface(s) 1706, mass storage device(s) 1708, and I/O device(s) 1710 to communicate with one another, as well as other devices or components coupled to bus 1714. Bus 1714 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1700 and are executed by processor(s) 1702. Alternatively, the systems and procedures described herein can be implemented in hardware, or a combination of hardware, software, and/or firmware. For example, one or more application specific integrated circuits (ASICs) or field programmable gate arrays (FPGAs) can be programmed to carry out one or more of the systems and procedures described herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the disclosure may be referred to herein along with alternatives for the various components thereof. It is understood that such embodiments, examples, and alternatives are not to be construed as de facto equivalents of one another but are to be considered as separate and autonomous representations of the disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure.

### EXAMPLES

The following examples pertain to further embodiments of the disclosure.

Reference throughout this specification to “an example” means that a particular feature, structure, or characteristic described in connection with the example is included in at least one embodiment of the disclosure. Thus, appearances of the phrase “in an example” in various places throughout this specification are not necessarily all referring to the same embodiment.

Example 1 is a reading assistant system comprising a computing device and a stereo audio output device. The computing device comprising an image sensor and a display. The image sensor is configured to detect eye activity of a user. The audio device is configured to output a sound from a first output of the stereo audio output device, a second output of the stereo audio output device, or both the first output and the second output of the stereo audio device. The computing device further comprises a processor and a non-transitory storage medium comprising software instructions that, when executed, cause the processor to direct the stereo audio output device to output the sound.

Example 2 is a system according to example 1, wherein the display is configured to output one or more lines of text, and wherein the system directs the user to read the one or more lines of text, and wherein the image sensor is configured to track the user’s eye activity while the user reads the one or more lines of text.

Example 3 is a system according to either of examples 1 or 2, wherein the processor is in electronic communication with the stereo audio output device, and wherein the processor is configured to direct output of the sound from the stereo audio according to an output rate generated by the system.

Example 4 is a system according to any of examples 1-3, wherein the software instructions further cause the processor to receive an input from a user, wherein the system uses the input to generate the output rate such that the stereo audio output device outputs the sound at a rate determined by user input.

Examples 5 is a system according to any of examples 1-4, wherein the image sensor is further configured to track the user’s eye activity, wherein the user’s eye activity comprises a per-word reading rate and a per-line reading rate.

Example 6 is a system according to any of examples 1-5, wherein the per-line reading rate further comprises a standard deviation, wherein the standard deviation is a measurement of a user’s eye activity travelling backwards along one of the one or more lines of text.

Example 7 is a system according to any of examples 1-6, wherein the display of the computing device is a touch screen, and wherein the system directs the user to place a finger on the touch screen while the user reads the one or more lines of text, and wherein the system is configured to detect where on the display the user is touching the touch screen while the user is reading the one or more lines of text.

Example 8 is a system according to any of examples 1-7, wherein the image sensor detects the hand of the user, and wherein the image sensor detects movement of one or more fingers of the hand of the user while the user reads the one or more lines of text.

Example 9 is a system according to any of examples 1-9, further comprising an icon on the display, wherein the icon is generated by the processor according to the software instructions, and wherein the system directs the user to direct the user’s vision onto the icon and move the computing device between a first position close to the user’s face and a second position at arm’s length from a user’s face.

Example 10 is a system according to any of examples 1-9, wherein the image sensor measures a distance where the user stops moving the computing device when the user is directing the user’s vision onto the icon to generate a near point distance.

Example 11 is a system according to any of examples 1-10, wherein the image sensor measures an alignment rate while the user is moving the computing device between the first position and the second position, and wherein the system directs the user to align the computing device with a bridge of the user’s nose if the system detects the computing device is not in alignment.

Example 12 is computer-implemented method. The method includes displaying text on a display of a computing device. The method includes capturing, by an image sensor, image data representing eye movements of a user while the user is reading the text. The method includes outputting a first sound from a first output of a stereo audio output device. The method includes outputting a second sound from a second output of the stereo audio output device, wherein the first sound and the second sound generate a spatialized audio signal that transitions between a first spatial position to a second spatial position over time at a first rate according to a predefined reading progression. The method includes measuring, by the image sensor and based on the image data, a reading rate based on a plurality of line-reading durations corresponding to time intervals during which a gaze of the user progresses across respective lines of the text in a first reading direction. The method includes modifying first rate of the spatialized audio signal transition between the first spatial position to the second spatial position to a second rate based on the reading rate.

Example 13 is a method according to example 12, wherein modifying the first rate to the second rate synchronizes a spatial position of the spatialized audio signal with a position of the gaze along the text on the display.

Example 14 is a method according to any of the examples 12-13, the method includes modifying second rate of the spatialized audio signal transition between the first spatial position to the second spatial position to a third rate based on input from the user, wherein the third rate is a target reading speed.

Example 15 is a method according to any of the examples 12-14, wherein the reading rate includes a per-word reading rate and a per-line reading rate based on measured eye activity of the user.

Example 16 is a method according to any of the examples 12-15, wherein the reading rate further comprises a standard deviation, wherein the standard deviation is a measurement of an eye activity of the user travelling backwards along one or more lines of the text.

Example 17 is a method according to any of the examples 12-16, wherein the display is a touch screen, and wherein the method includes instructing the user to place a finger on the touch screen while the user reads the one or more lines of the text and detecting where the user is touching the touch screen while the user is reading the one or more lines of text.

Example 18 is a method according to any of the examples 12-17, the method includes outputting a third sound that instructs the user to move a hand of the user as the user reads the text; and detecting, via the image sensor, a finger or the hand of the user while the user reads the one or more lines of text.

Example 19 is a method according to any of the examples 12-18, the method includes displaying an icon on the display; and directing the gaze of the user to the icon as the display moves between a first position close to a face of the user and a second position at arm length from the face of the user.

Example 20 is a method according to any of the examples 12-19, the method includes receiving input from the user that the icon is located at a near point distance associated with the user as the display moves between the first position and the second position.

Example 21 is a method according to any of the examples 12-20, the method includes determining the user has Binocular Convergence Deficiency (BCD) based on the near point, without using ophthalmic equipment.

Example 22 is a method according to any of the examples 12-21, the method includes

measuring an alignment rate while the displayed is moved between the first position and the second position; detecting the display is not in alignment with a bridge of a nose of the user; and directing the user to align the display.

Example 23 is a method according to any of the examples 12-22, the method includes detecting, from the image data, directional gaze movements opposite the first reading direction and detecting the user is re-reading a portion of the text.

Example 24 is a method according to any of the examples 12-23, the method includes detecting, from the image data, directional gaze movements opposite the first reading direction and detecting the user is advancing to a next line of text.

Example 25 is a method according to any of the examples 12-24, the method includes determining, by correlating a position of the gaze of the user with a spatial position of the spatialized audio signal, whether a deviation between the position of the gaze and the spatial position of the spatialized audio signal exceeds a threshold indicative of attention loss.

Example 26 is a system, the system including, a display of a computing device configured to display text. The system including, an image sensor configured to capture image data representing eye movements of a user while the user is reading the text. The system including, a first output of a stereo audio output device configured to output a first sound. The system including, a second output of the stereo audio output device configured to output a second sound, wherein the first sound and the second sound generate a spatialized audio signal that transitions between a first spatial position to a second spatial position over time at a first rate according to a predefined reading progression. The system including, a processor configured to measure a reading rate based on the image data and a plurality of line-reading durations corresponding to time intervals during which a gaze of the user progresses across respective lines of the text in a first reading direction and configured to modify first rate of the spatialized audio signal transition between the first spatial position to the second spatial position to a second rate based on the reading rate.

Example 27 is a system according to the example 26, wherein the processor is configured to synchronize a spatial position of the spatialized audio signal with a position of the gaze along the text on the display.

Example 28 is a system according to any of the examples 26-27, wherein the reading rate further comprises a standard deviation, wherein the standard deviation is a measurement of an eye activity of the user travelling backwards along one or more lines of the text.

Example 29 is a system according to any of the examples 26-28, wherein, the processor is further configured to determine, by correlating a position of the gaze of the user with a spatial position of the spatialized audio signal, whether a deviation between the position of the gaze and the spatial position of the spatialized audio signal exceeds a threshold indicative of attention loss.

Example 30 is computer-implemented method. The method includes displaying text on a display of a computing device. The method includes capturing, by an image sensor, image data representing eye movements of a user while the user is reading the text. The method includes outputting a first sound from a first output of a stereo audio output device. The method includes outputting a second sound from a second output of the stereo audio output device, wherein the first sound and the second sound generate a spatialized audio signal that transitions between a first spatial position to a second spatial position over time at a first rate according to a predefined reading progression. The method includes measuring, by the image sensor and based on the image data, a reading rate based on a plurality of line-reading durations corresponding to time intervals during which a gaze of the user progresses across respective lines of the text in a first reading direction. The method includes detecting, from the image data, directional gaze movements opposite the first reading direction. The method includes distinguishing whether the directional gaze movements opposite the first reading direction is the user is re-reading a portion of the text or the user is advancing to a next line of text.

Example 31 is a method according to the example 30. The method includes determining a standard deviation of an eye activity of the user based on the directional gaze movements opposite the first reading direction, and the distinguishing between re-reading and advancing is based on the standard deviation.

What is claimed is:

1. A computer-implemented method, the method comprising:
displaying text on a display of a computing device;
capturing, by an image sensor, image data representing eye movements of a user while the user is reading the text;
outputting a first sound from a first output of a stereo audio output device;
outputting a second sound from a second output of the stereo audio output device, wherein the first sound and the second sound generate a spatialized audio signal that transitions between a first spatial position to a second spatial position over time at a first rate according to a predefined reading progression;
measuring, by the image sensor and based on the image data, a reading rate based on a plurality of line-reading durations corresponding to time intervals during which a gaze of the user progresses across respective lines of the text in a first reading direction; and
modifying first rate of the spatialized audio signal transition between the first spatial position to the second spatial position to a second rate based on the reading rate.

2. The method of claim 1, wherein modifying the first rate to the second rate synchronizes a spatial position of the spatialized audio signal with a position of the gaze along the text on the display.

3. The method of claim 1, further comprising:
modifying second rate of the spatialized audio signal transition between the first spatial position to the second spatial position to a third rate based on input from the user, wherein the third rate is a target reading speed.

4. The method of claim 1, wherein the reading rate includes a per-word reading rate and a per-line reading rate based on measured eye activity of the user.

5. The method of claim 1, wherein the reading rate further comprises a standard deviation, wherein the standard deviation is a measurement of an eye activity of the user travelling backwards along one or more lines of the text.

6. The method of claim 1, wherein the display is a touch screen, and wherein the method comprises:
instructing the user to place a finger on the touch screen while the user reads the one or more lines of the text; and
detecting where the user is touching the touch screen while the user is reading the one or more lines of text.

7. The method of claim 1, further comprising:
outputting a third sound that instructs the user to move a hand of the user as the user reads the text; and
detecting, via the image sensor, a finger or the hand of the user while the user reads the one or more lines of text.

8. The method of claim 1, further comprising:
displaying an icon on the display; and
directing the gaze of the user to the icon as the display moves between a first position close to a face of the user and a second position at arm length from the face of the user.

9. The method of claim 8, further comprising:
receiving input from the user that the icon is located at a near point distance associated with the user as the display moves between the first position and the second position.

10. The method of claim 9, further comprising:
determining the user has Binocular Convergence Deficiency (BCD) based on the near point, without using ophthalmic equipment.

11. The method of claim 8, further comprising:
measuring an alignment rate while the displayed is moved between the first position and the second position;
detecting the display is not in alignment with a bridge of a nose of the user; and
directing the user to align the display.

12. The method of claim 1, further comprising:
detecting, from the image data, directional gaze movements opposite the first reading direction and detecting the user is re-reading a portion of the text.

13. The method of claim 1, further comprising:
detecting, from the image data, directional gaze movements opposite the first reading direction and detecting the user is advancing to a next line of text.

14. The method of claim 1, further comprising:
determining, by correlating a position of the gaze of the user with a spatial position of the spatialized audio signal, whether a deviation between the position of the gaze and the spatial position of the spatialized audio signal exceeds a threshold indicative of attention loss.

15. A system comprising:
a display of a computing device configured to display text;
an image sensor configured to capture image data representing eye movements of a user while the user is reading the text;
a first output of a stereo audio output device configured to output a first sound;
a second output of the stereo audio output device configured to output a second sound, wherein the first sound and the second sound generate a spatialized audio signal that transitions between a first spatial position to a second spatial position over time at a first rate according to a predefined reading progression; and
a processor configured to measure a reading rate based on the image data and a plurality of line-reading durations corresponding to time intervals during which a gaze of the user progresses across respective lines of the text in a first reading direction and configured to modify first rate of the spatialized audio signal transition between the first spatial position to the second spatial position to a second rate based on the reading rate.

16. The system of claim 15, wherein the processor is configured to synchronize a spatial position of the spatialized audio signal with a position of the gaze along the text on the display.

17. The system of claim 15, wherein the reading rate further comprises a standard deviation, wherein the standard deviation is a measurement of an eye activity of the user travelling backwards along one or more lines of the text.

18. The system of claim 15, wherein, the processor is further configured to determine, by correlating a position of the gaze of the user with a spatial position of the spatialized audio signal, whether a deviation between the position of the gaze and the spatial position of the spatialized audio signal exceeds a threshold indicative of attention loss.

19. A computer-implemented method, the method comprising:
displaying text on a display of a computing device;
capturing, by an image sensor, image data representing eye movements of a user while the user is reading the text;
outputting a first sound from a first output of a stereo audio output device;
outputting a second sound from a second output of the stereo audio output device, wherein the first sound and the second sound generate a spatialized audio signal that transitions between a first spatial position to a second spatial position over time at a first rate according to a predefined reading progression;
measuring, by the image sensor and based on the image data, a reading rate based on a plurality of line-reading durations corresponding to time intervals during which a gaze of the user progresses across respective lines of the text in a first reading direction;
detecting, from the image data, directional gaze movements opposite the first reading direction; and
distinguishing whether the directional gaze movements opposite the first reading direction is the user is re-reading a portion of the text or the user is advancing to a next line of text.

20. The method of claim 19, further comprising:
determining a standard deviation of an eye activity of the user based on the directional gaze movements opposite the first reading direction, and the distinguishing between re-reading and advancing is based on the standard deviation.
